(19) United States
(12) Patent Application Publication
(10) Pub. No.: US 2011/0275045 A1
(43) Pub. Date: Nov. 10, 2011

(54) Video Overlay Sports Motion Analysis

(75) Inventors: Shiv Kumar Bhupathi, Mequon, WI (US); William Michael Foerster, Dallas, TX (US)

(73) Assignee: Foerster Bhupathi International, L.L.C., Dallas, TX (US)

(21) Appl. No.: 13/188,365

(22) Filed: Jul. 21, 2011

(30) Foreign Application Priority Data
Jan. 22, 2010 (US) PCT/US2010/021878

(51) Int. Cl. G09B 19/00

(52) U.S. Cl. 434/247

(57) ABSTRACT

Methods and system for providing a video overlay sports motion analysis. An embodiment method comprises receiving files containing video frames recording a professional athlete's performance of a motion and video frames of a student's performance of the motion. A stick figure representation of the professional athlete's motion is provided as a video sequence, and the video sequence is aligned to, and overlaid with, outlines of the student athlete. A playable video file providing a visual comparison between the student athlete's motion and the motion of the professional is created and delivered. Differences between the two motions are ascertained. A representation of the student performing the motion correctly is created and stored to enable playback; enabling the student to mentally visualize himself/herself performing the correct motion. The embodiments provide a turnkey system usable from anywhere worldwide by any student or coach at low cost.

This application claims the benefit of U.S. Provisional Application No. 61/146,946, entitled “Video Overlay Sports Motion Analysis,” filed on Jan. 23, 2009, and PCT Application No. PCT/US2010/021878 entitled “Video Overlay Sports Motion Analysis,” filed on Jan. 22, 2010, which applications are incorporated herein by reference.

### TECHNICAL FIELD

The present invention relates generally to a system and methods for receiving a video sequence of a desired series of human motions known to be correct and a video sequence from another person performing the motions, and performing a process to create a video overlay sequence that allows visual analysis of the motions by the other person and demonstrates to the other person how to perform the motions correctly. More particularly, the present embodiments described in the application relate to a system for performing a video overlay sports motion analysis for sports training by creating a visual sequence of a correct motion such as a visual sequence of a professional athlete's or trainer's motions overlaid with a student athlete's motions to document the similarities and differences between the student's motion and the professional or trainer's motion. Using the student's video and the overlaid visual analysis, the student's motions may then be modified to the correct motions. The student's modified video analysis may be used to form, in the student's “mind's eye”, how the student's motions should be executed so as to perform the motions perfectly or correctly.

### BACKGROUND

Generally, sports training involves performing practice motions while being observed by a coach, instructor or trainer. The student receives instruction, usually in the form of verbal commands or corrections, and sometimes using graphical aids. Then, the student must attempt to apply these instructions to correct their own motions, positions or form so as to perform a particular motion or series of motions in an effective manner.

A problem with traditional sports training is that the student is told, often using only verbal information, how to change their own position or motions in playing the sport to correct their errors. The student typically cannot observe themselves performing the motions. Training films and training videos have sometimes been used to enable the student to visually observe their own motions. However, the student must still determine how their own performance of the physical motions should change to a more effective motion based primarily on verbal input from the trainer or coach.

Side by side video analysis is sometimes also used. A video of the student may be played in a side by side viewer simultaneously alongside a similar series of motions performed correctly, for example, a video sequence of a professional athlete. However, these side by side comparisons still require the student and coach to determine how to change the student's motions, position or form without any objective information about how the motion differs, in any exact way, from the correct motion or position. The student must mentally compare two disparate images and discern how to change his/her motions to approach the correct motion. Even these primitive approaches are presently quite expensive and thus, out of reach for many student athletes or sports enthusiasts.

Most often, the student cannot visually see the difference between the professional's motion and their own motion, because the student has to rely only on spoken words or commands from an instructor. Even if video of the student or a professional is available, the student must rely on their own mind's ability to perceive these pictures or videos. Then, the student must do a mental comparison of their own motion compared to a correct motion because the student has to rely on an instructor's or trainer's verbal cues. If the student and instructor somehow experience a miscommunication about what changes should be made in the student's motion, the student will incorrectly change his/her own motion. In traditional sports training this process is often repeated many times in many practice sessions, because the student has no ability to correctly perceive the differences between his/her own motion and the correct motion as performed by a professional.

In some known athlete training processes, a biometric analysis may be used. In this approach, a variety of position sensors coupled to wires are applied to a person (athlete or student athlete). Using dedicated hardware, the movements of the student are measured and captured. In some systems the motion may then be displayed as a moving graphical image to provide visual information about the student's own motion. The student must still rely on an instructor's verbal explanation of how the motion is incorrect, and must then form a mental image and apply the instructor's suggestions to the motion. The requirement that the athlete be coupled to a proprietary, dedicated hardware system for biometrics limits the overall availability of this approach; most students learning or training in a sport simply cannot afford this form of instruction.

The prior art approaches to providing comparative visual training require expertise in the coach or student, expensive facilities, advanced video capabilities, special software, a person that has spent significant time learning the software and using the software on a consistent basis as to be competent, and generally in an environment that is cost prohibitive for all but a very few tennis athletes. The result is that this type of training is only available through private clubs or elite schools and is very expensive. Some of the systems require the coach or trainer to have skills in video editing and computer file manipulation that require additional training or the use of specialists to prepare and process the videos for comparison. Systems known in the art are difficult to use, many times are not used after the initial outlay of funds to purchase the software and more importantly are not available to many students or athletes in training. The systems are not available to people in many countries or athletes who do not have access to elite training facilities, and even for those athletes, the costs associated with the prior art visual training techniques are often prohibitive.

A continuing need thus exists for a visual motion analysis tool for sports training that provides athletes, located anywhere in the world, and/or their instructors immediate, affordable, easily comprehended information about how to correct their motions and to provide a way for the athletes to visualize themselves performing the correct motion and using the correct positions.

### SUMMARY

These and other problems are generally solved or circumvented, and technical advantages are generally achieved, by embodiments of the present invention which provide a system and methods for forming a visual overlay sports motion analysis (“VOSMA”). In some non-limiting and illustrative examples presented for explanatory purposes herein, the system is applied to tennis as an example sport, and the term visual overlay tennis and sports analysis (“VOTSA”) may be used. However, the embodiments and the scope of the claims are not limited to any particular sport or activity and the embodiments may be applied to any human motions such as dance, any sports, and individual and team activities. The use of the terms VOTSA and VOSMA herein are for convenience and generally mean a visual overlay motion analysis system.

Embodiments of the system and the methods presented below provide an affordable visual sports motion training tool that is available to any student or athlete in training world wide. The tools provided with the output video files are easy to use by anyone who can use a mouse device, point, click and type and may be accessed at any computer. The cost of the training analysis is low because the system provides a turnkey feature. A video file of the student or athlete in training is provided to the system over, for example, a web based interface or otherwise as a file. The analysis may be performed at a remote location by an operator experienced with the system and an output file is returned, again by a file transfer or by accessing a file over a web interface. No further manipulation of the video file is needed once the end user (student or athlete) receives the output file. The coach and student can observe the visual comparison and playback of the student video, still frames, and other output tools using a straightforward interface at any computer, anywhere. No particular expertise with video files or computer skills is needed. The video output is provided in a turnkey fashion, making the visual analysis affordable and accessible even to persons in poor countries or at a low economic status. The use of the visual analysis advantageously provides the student immediate documentation of the errors in performing the motion and by correcting the motion and making subsequent videos, the coach and student can rapidly and affordably document the student's progress towards the correct motion. Surprisingly, the use of the visual analysis results in rapid improvement in the student's motion as the embodiments enable the student to visualize, in his/her “mind's eye”, the correct motion and this enables the student to rapidly correct his/her performance of the motion.

The student and his/her instructor can use the video output files of the VOSMA/VOTSA to visually compare, viewed at any playback speed including normal speed or in altered time views and even frame by frame, the student's motion to a correct motion, and to create an image or visual sequence of the student athlete in the correct motions or performing the correct sequence. The correct motions are provided from video analysis of stored video files of a professional athlete or trainer and a process is performed to form a digital video sequence stored in an output file overlaying the correct motion of the professional with the motion of the student athlete. In another alternate embodiment, an animated figure performing technical correct motions may be used to form a visual sequence of the motion in a digital video sequence stored as an output file. Various key points are identified as described further below and provided in several different formats in an easy to use analysis tool. Additional files may be provided where the student video sequence has been analyzed and key points in a motion or sequence performed by the student have been identified, and visual correction artifacts may be added to the sequence for playback, indicating where the student's position or motions need correction. In addition to performing a visual comparison to a recorded visual sequence of a professional athlete performing a correct motion or position, animated figures that perform the motion in a technically correct fashion may be used in a visual sequence for comparison to the student athlete's video sequence file, and an output file may be created comparing the two motions. The visual sequence files of the student may be recorded at different times or on different dates and stored for retrieval so that, by performing a visual comparison and analysis and creating an output video file containing an overlay and comparison between two different performances of the motions by the student, a visual sequence showing the effect of changes the student makes in performing the motion and in taking positions may be created and permanently stored as a digital file for subsequent playback and viewing. The system and methods of the preferred embodiments are compatible with existing consumer computer devices including without limitation PCs, laptops, cellphones, PDAs, MP3 players and video cameras, and the tools and files are easily accessible to most student athletes without additional expensive equipment purchases. No special tools or dedicated hardware are required.

The embodiments rapidly improve student athlete performance in a variety of activities, including sports with balls such as tennis, baseball, soccer, football, other sports such as skiing, snowboarding, cycling, gymnastics, diving, shooting, archery and the like, or other human motion activities such as dancing, ballet and the like. Analysis of the motion of animal athletes in training, such as racehorses, is possible using the system. The embodiments are compatible with widely distributed and available consumer grade technology without the need for dedicated hardware or proprietary systems or expertise, thus the visual analysis tools of the embodiments will make visually enhanced sports training available to the masses, regardless of their socio-economic situation or country of residence, in a manner not previously accomplished.

### BRIEF DESCRIPTION OF THE DRAWINGS

For a more complete understanding of the embodiments, and the advantages thereof, reference is now made to the following descriptions taken in conjunction with the accompanying drawing, in which:

FIG. 1 illustrates in a simple system diagram, computers that may be used with the embodiments;

FIG. 2 is a flow diagram illustrating, for an exemplary method embodiment, steps that may be performed;

FIG. 3 is another flow diagram illustrating, for the method of FIG. 2, additional steps that may be performed by the embodiment method;

FIG. 4 is a flow diagram illustrating method steps that may be performed by another embodiment;

FIG. 5 is a block diagram of the four squares of a communication embodiment; and

FIG. 6 is a flow diagram illustrating the method steps of a video history embodiment.

The figures are illustrative, and are not to scale, and some features may be omitted for clarity. Like reference numerals for like elements are used.

### DETAILED DESCRIPTION

The making and using of the presently preferred embodiments are discussed in detail below. It should be appreciated, however, that the embodiments provide many applicable inventive concepts that can be applied in a wide variety of specific contexts. The specific embodiments discussed are merely illustrative of specific ways to make and use the embodiments, and do not limit the scope of the embodiments or the appended claims.

In a first embodiment, a video file library of correct motions in a sport is stored; for example, as an inventory of video sequences in non-transitory tangible media storage in a digital format, or in a tangible memory as computer readable formatted files, or in a central location such as a server. Other forms of storage may be used, and the storage may be distributed over many computers or locations as well. The video library of correct motions may include, for example and without limitation, one or more video sequences of a professional athlete performing the motion, one or more video sequences of a trainer or coach performing the correct motion, one or more video sequences of an animated stick figure performing the correct motion, and/or one or more video sequences of an advanced amateur or elite junior athlete performing the correct motion. Portable non-transitory tangible media such as thumb drives, CD ROMs, diskettes, non-volatile cards, compact flash cards, SIM cards, etc. may be used to store the video files in the video library. The files may be transferred electronically from the computer to another computer system via email, using file transfer protocol (“FTP”) over the Internet, attached to messages, etc. Student athletes may provide as an electronic file digital video segments of their own motions captured using any point-and-shoot camera with video capability, camcorder or the like. These video files may be provided as motion pictures expert group (“MPEG”) or other commonly used digital video information storage formats. The student may also choose from the library, via a computer or remote connected computer over the Internet, for example, the performance of a particular professional athlete, trainer, coach, amateur or elite junior in the stored inventory as the correct motion to be used.

In another embodiment, a process of analysis of the video sequence containing the selected correct motion example is performed. Key frames in the video sequence are identified, and templates (which may be, in one example, in the form of stick figures) are formed of the correct size for each frame and identifying key events, such as identifying the initial ready position prior to a motion or movement, a change in motion or position, an implement such as a racquet or bat being readied, moving to a hitting position, or striking a ball, or a change in foot, arm, shoulder, head, or torso position. The templates are then removed from the video and used to form a digital video sequence file representing the correct motion. This file is stored in a tangible digital media, such as on a hard drive or server. The student video file is then also analyzed, the key frames identified, and the images of the student athlete are isolated in another video sequence file including the key events. The analysis may include any or all positions of the athlete, including hands, feet, arms, limbs, head, eyes, wrists, knees, elbows, etc. The analysis may include identifying foot positions at certain points in the motion and isolating or highlighting footwork during a motion or at a ready position. The template forms from the file containing the correct motions or professional athlete's motions are then overlaid on the images of the student athlete. A visual overlay file of the two motions is completed containing a visual sequence for display, and the visual overlay file is also stored in a non-transitory tangible medium. This digital visual overlay file then provides a capability for visual analysis that is a video sequence of images visually comparing the motion of the student to the professional athlete. Playback may be provided by displaying the video overlay file “frame-by-frame” or at various playback speeds, and additional visually significant artifacts may be incorporated into the video file for providing additional visual cues to be viewed. An artifact may be any visual cue such as an arrow, pointer, stick figure, or a circle or color around an object to highlight its position, such as a racquet, bat, ball, or the player's feet, hands, arms, limbs, or a piece of equipment such as a gymnast's ring or pommel horse, an out of bounds line, or any other part of a visual frame. These artifacts are added to the video file containing the visual sequence in order to highlight or make obvious certain positions, changes in position and relationships between the athlete and other objects such as a racquet, bat or ball, or boundary lines, nets, etc. during the motion being analyzed.

An important feature of another embodiment is a grip analysis. By analyzing still images depicting an individual's grip from several views, such as on the palm side of a professional athlete or trainer, the back of the hand of the professional athlete or trainer, and over the top of the hand, the type of grip may be characterized. In the analysis, additional artifacts such as lines indicating bevels, and numbering of the bevels themselves on a racquet or club may be added as visual cues for the student and used to further assist the characterization of the player's grip. Because in many activities, more than one grip is recognized as a proper grip, it is an important feature of the embodiments that the correct motion selected for comparison be one for a professional or technically correct performance of a player using the same grip as the student. Comparisons of two performances where different, although correct, grips are used are not as useful in training because the correct motion depends on the grip in use. The grip analysis thus ensures that the videos selected for comparison are optimally selected to enhance the results of the visual comparison presented to the student. Also any errors or needed modifications to the student's grip can be determined and pointed out as visual cues in the grip analysis.

In additional embodiments, the visual analysis is provided in various video formats stored in computer readable media. In one video format, the swing path of an implement used in a sport, such as a bat or racquet, is measured and displayed visually while simultaneously displayed compared to the professional's swing path. In another video format embodiment, shoulder motion of the student is analyzed and a video file is provided that visually compares the shoulder motion to the professional's shoulder motion. In yet another video format embodiment, the student's line of sight and eye position are analyzed from the student's video files and compared to a measured ball position to illustrate when the student stops watching the ball, for example. Again, this video format may be provided as a file containing a visual comparison sequence to the professional athlete.

In yet another embodiment, the visual analysis may be provided to produce a video file stored in a tangible computer storage media. The file contains video frames forming a visual sequence for playback that shows the contact position of an implement manipulated by the student athlete, for example, a racquet or bat, and the ball being struck. Again, the correct motion video file or professional motion video file is analyzed and the resulting analysis may be provided as a video file containing an overlay for visual comparison.

In another embodiment, an object tool is provided to enable finding key objects or events in a video sequence. Specific positions of selected objects such as a ball or the athlete's hands, wrists, arms, knees, etc. are determined from analyzing a video sequence. The tool enables cutting video images and drawing additional objects such as artifacts including, without limitation, images in frames for use in the video analysis. This tool overcomes any problem where the relative position of an object at a point in time is not readily ascertainable from the video frame sequence.

Because the human eye integrates information, watching the video files displayed as a continuous sequence may provide a complete view of the events, however, the video frame series shared in the file may not provide any frame that depicts, for example, the actual impact of a ball with a racquet. The tool provided by these embodiments enables any missing virtual information to be created, stored, and shared for use in the visual analysis.

In another embodiment, a user interface environment is provided for using the visual analysis created by the embodiments described above in a convenient manner. This user interface is compatible with existing PCs, laptops, cellphones, PDAs and the like. The user interface package includes the ability to play the student video, the correct motion or professional athlete original video, the overlay video including the visual analysis artifacts, the swing path video, and other analysis videos such as ready position, position transition, ball path, shoulder turn, and contact, in a variety of ways including slow, fast, regular video speeds, and frame by frame views. Still images may be extracted from the video analysis, overlay comparison, and other files for visual display, storage in tangible digital media as files, printing for providing paper copies, and the like.

The visual analysis tool output may be provided in any number of formats that are compatible with existing consumer devices, including but not limited to files that are emailed or transferred over the Internet, downloaded from a website to the user's computer, a portable USB or flash drive, DVD discs, or any other convenient medium for storing video frames. FTP file transfer protocol services may be used to transport the video files to the user's computer from a central server or remote site.

In yet another preferred embodiment, a user interface is provided that allows the student athlete, parents or mentors, professional trainers or coaches, school coaches, or other interested parties, using a computer or PDA and a web-based user interface, to communicate on the progress of the student athlete. The communications between all the persons involved in the athlete's training is critical to the athlete's success, especially in a very common instance when more than one coach is involved and more than one person is scheduling practices, drills and the like for the student to perform. In order for these efforts to be coordinated so that the student athlete is given consistent drills and instruction that are not conflicting at different practices and drill sessions, the coaches and parents need to be informed of the observations and recommendations made by the other persons involved in the training. In the communication embodiment, the system allows coaches' notes for the video analysis to be created and stored for each frame of the video analysis or by analysis page. These notes are coordinated with the visual sequences and stored in a non-transitory tangible medium in a manner where they can be retrieved for playback by the other persons involved, or by the athlete. The notes may include suggested drills and practice routines designed to correct the errors in the athlete's motions or positions. The communications tool embodiment includes a calendar with a workout and school commitment tracking system so that all of the parties are informed of the time commitment and efforts put forth by the student. The communication embodiment allows for the use of additional features such as automatic messaging, including text messaging and emailing of updates made through the calendar function. In this way, communication is facilitated between the athlete/trainee and the other persons involved in the training program.

In yet another preferred embodiment, a video graph or video history feature is provided. This video graph or video history feature allows the student's motions and the progress in attempts to correct the motions to be documented. Video files containing video of the athlete performing the motions are stored with individual date or time stamps. These stored video files may be added as retrievable files on a user interface such as a web page. Comparison video files may be created for playback presenting a visual comparison between the student videos. These visual comparisons may be presented in side by side visual displays. Alternatively, one video file can be used as an overlay file and a visual overlay video file can be created with another video file, displaying the athlete's motions captured at different times in a visual overlay comparison. The video graph feature of this embodiment allows the benchmarking and documentation of a trainee's progress.

Another important feature provided with the embodiments is an automatic synchronization (“auto sync”) feature. This feature is used during playback of two visual files, for example in a side by side comparison; the two video sequences may have different lengths (number of frames). The auto sync function will automatically advance both sequences to a common point; say a “ready position” for both motions. Surprisingly, in many comparisons the correct motion (such as by a professional) and the student motion are quite different at the “ready position” and just after. This is because the professional has already started moving towards the contact point, while the student often delays his/her motion. Correcting this very early difference in the two motions surprisingly improves the student performance very rapidly. The visual comparison and auto sync features of the embodiments provide the student with instant understanding of this concept and make it very easy for the student and his/her coaches to take corrective action.

In yet another embodiment, a video sequence of the student athlete's motion, or an individual frame or frames of the student athlete's motion, is altered using the tools of the system. The altered visual sequence or frame is used to present a visual image or video sequence of the athlete shown performing the motion using the technically correct positions and movements. This file is then stored in a non-transitory tangible medium for playback. This feature allows the student to see a visual representation of himself/herself performing the motion correctly. The student can then form a mental image of themselves performing the motion correctly in their mind, which makes it possible for the student to perform the motion correctly.

The exemplary embodiments will be described with respect to preferred embodiments in a specific context, namely the use of the VOSMA/VOTSA system, and embodiments, to perform visual overlay motion analysis of the strokes of a tennis athlete. However, the reader should understand that the various embodiments have a wide range of applications. The embodiments including, for example, the Ultimate Pro Compare (“UPC”) process described further below have application to all sports movements including baseball, golf, basketball, soccer, cricket, football, and gymnastics, just to name a few. Using these embodiments and combinations of these embodiments, any human motion may be analyzed in a visual overlay analysis of a correct motion with a student or trainee's motion. Animal motions can also be analyzed using the embodiments. The fields of sports, dance, and other physical endeavors are all suitable environments for application of the embodiments. The term “student” and “student athlete” used below describes a person who is being trained to perform a correct motion, and is not meant to limit the description to youth or junior athletes, or persons in any particular school, although these are all examples of possible users of the embodiments.

In describing the application of the VOTSA to tennis, the UPC may be used. This process creatively combines technology including digital camera and digital video camera recorder (camcorder) technology, information technology (software, hardware, and the Internet), graphical arts technology (computer aided design (CAD) and computer graphics and illustration), storing and retrieval of digital video files stored in non-transitory tangible media that is computer readable, sports technique and training expertise, and process management expertise to produce the VOSMA/VOTSA process. The VOTSA process applied to tennis creates an output referred to as “The VOTSA Package.”

In general, the UPC process compares an athlete's motions in the performance of a sport, here tennis for example, with a correct motion. This correct motion can be, for example, video of a professional athlete performing the motions in the same sport. Alternatively, the correct motion video may be video of a trainer or coach, video of an accomplished amateur, or video of an elite junior player performing the motion correctly. In another alternative, the correct motion may be performed by animated figures such as stick figures, provided as a digital video file that may display an animated visual sequence of the correct motion. The VOTSA package outputs a visual overlay technical analysis; and a simple to use user interface environment is provided for quickly using the visual overlay technical analysis as a training tool to improve the performance of the student athlete.

A unique aspect of the UPC from the user's point of view is that the process relies on readily available, user friendly technology to produce high quality technical sports analysis; thereby placing the visual overlay sports analysis of the embodiments within the economic reach of the masses, and thus helping to promote the learning of, and improvements in, all sports. Unlike prior art systems that require the student to travel to a particular facility, undergo biometrics or expensive custom video motion analysis, and which require substantial costs for each student, the various embodiments are available to all athletes using technology that is readily available to most consumers and school programs.

In another embodiment, as described in more detail below, a tool referred to as the Finding Object Positions (FOP) tool is provided to enable the video analysis process to be efficient in both time and costs. This tool enables an operator to quickly identify key positions of objects or persons in a video sequence of sports motions for use in the visual analysis.

In another embodiment, visual analysis tools include a set of specially developed drawing tools. These tools allow for the addition of visual cues such as a clock, an angle wheel, a grid, and drawing lines and other geometric shapes indicating ball travel into or out of a frame, travel of the athlete or an implement used by the athlete, relative positions, etc. The use of these drawing tools may surprisingly provide information not present in the video that is important, such as the impact point of a ball and a racquet, bat, hand, etc. By using these tools, the operator can add critical information to the student's video output file, showing critical points and positions in the motion. This allows the coaches and or students' mentors or students themselves to highlight on the video and show the students' differences and similarities to the correct position in a manner that highlights critical points and positions.

The VOTSA embodiment directed to tennis provides an analysis as a stored digital video file that visually displays a sequence that compares the student athlete's tennis stroke to a professional tennis player's (or other correct movement) stroke and provides a visual overlay for visual examination in a variety of formats, described in detail below.

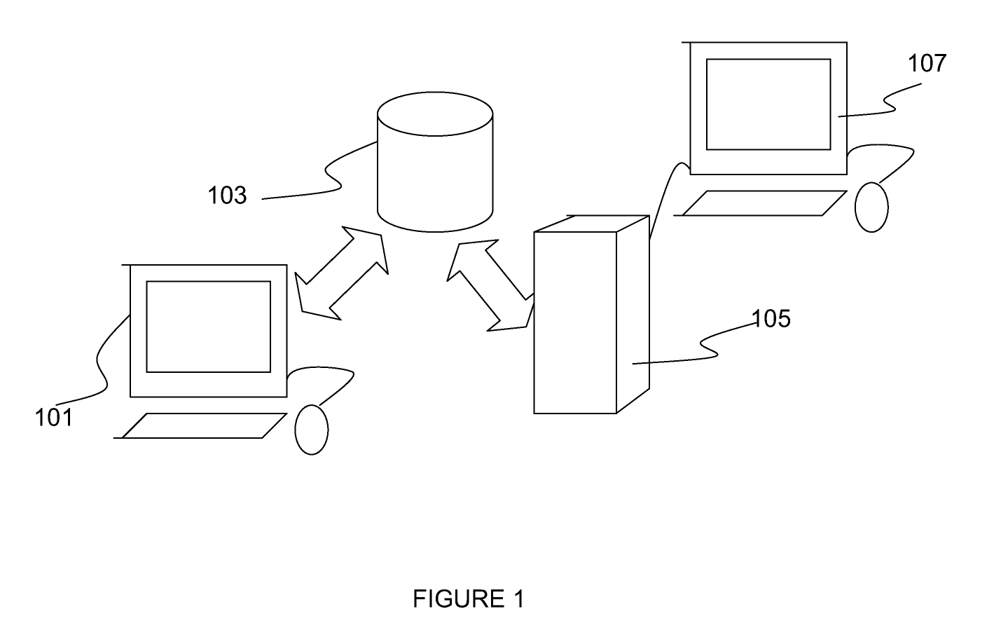

FIG. 1 depicts, in a simplified system diagram, the computers arranged in a manner so that they may be used with the embodiments. A user may interface with the system using a home or personal computer or any available computer, 101. This may be a personal computer, laptop computer, including netbooks and notebooks, cellphones, smartphones, PDAs, web appliance or other devices capable of sending and receiving video files, using services such as email attachments, file transfer protocol (FTP), upload and download over a web interface, and even by storing and retrieving files from physical devices such as USB drives that may be exchanged by mail.

The system also has video editing computers such as a computer or workstation 107. This workstation may have local storage of digital video files in a hard drive or disk array 105. In an alternative embodiment, a server such as that provided by a web hosting service depicted as server 103 may be used to store and retrieve various video files, overlay files, frame sequence files, and templates as further described below. The computers 101 and 105 may be connected to the server 103 and to each other, as indicated by the input/output arrows in FIG. 1, in a variety of ways. Wi-Fi and wireless connections, Ethernet cabling, and other wired, optical, wireless and cellular internet connections may be used, for example. Dedicated lines such as T1 lines may be used, and modems may use optical networks or phone networks to connect the computers. In a simple example, files may even be provided and exchanged by physically delivering storage media such as, for example, and not limiting the embodiments, a compactFLASH card or USB drive exchanged by mail. Typically, the Internet connections, and file transfer protocols using Internet and web based interfaces will be used to provide user files to the operator at the video editing computer, and to deliver results files to the user instantaneously and without regard to the physical location of the users.

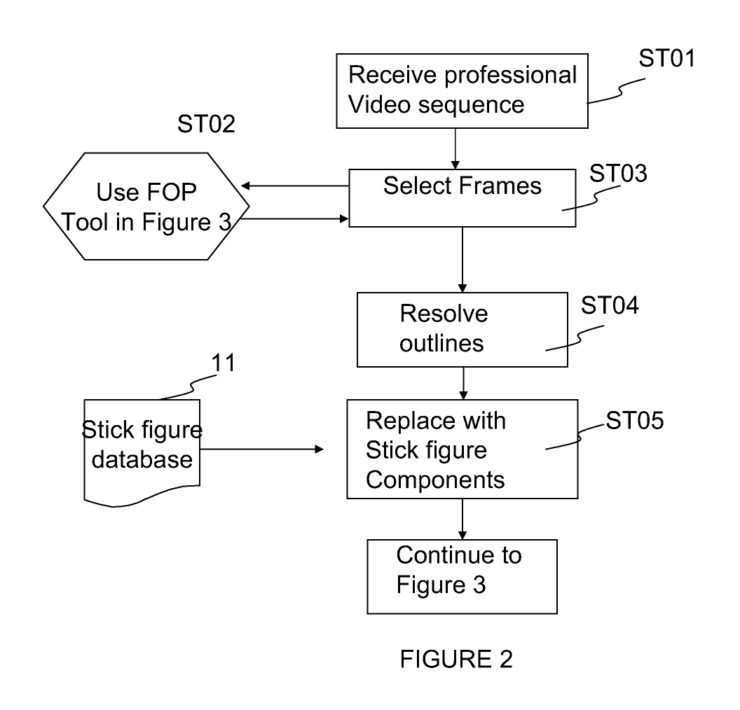

FIG. 2 depicts, in a simple flow diagram, steps of an exemplary method embodiment. In step ST01, a professional video sequence is received. The video sequence is provided as a stored digital video file stored in a non-transitory tangible medium such as a hard drive, server, PC, or other computer storage. As an element of the process, an inventory of files containing video sequences of various professional tennis players' strokes is maintained. The inventory may also include video sequences of the motions performed by trainers, coaches, accomplished amateur players, and elite junior players, as non-limiting examples. Animated sequences may be stored as digital video files that, when played back for display, provide a visual sequence of the correct motion, using for example stick figures or other animated figures. The information may be stored as video sequences in common file formats used for video information, for example, in the motion picture experts group (“MPEG”) format, and stored in any number of ways, including memory, DVD ROM, flash drives, hard drives, solid state drives and the like; and may be stored in a central location such as a server coupled to the Internet or a proprietary network, or in a distributed manner. Still photos or still video images may be included as part of the inventory as well. In FIG. 2, element 11 represents the stick figure database.

To begin the analysis of a student's stroke, the student merely provides in any convenient manner a video file containing a video sequence of his/her performance of the motion or stroke. This video can be taken with any video capable device including a camera with video capability, a camcorder, cellphone, PDA or the like. The file may be transmitted stored on a non-transitory tangible medium such as a USB card, thumb drive, flash card, or file transfer services such as attachments to an email, uploading to a web interface, and the like. The student may then also indicate which professional athlete from a list of available professional athletes should be used for the comparison analysis.

The inventory of strokes stored for the professionals and students may include several formats.

Video files may be recorded and stored at frame speeds from 15 fps to 1200 fps. These video files record the professional's (and student's) stroke. For example, a sequence may begin at the ready position, or at the setup of a tennis shot and continue through the completion of the tennis swing and the set up for the next shot. Other examples, such as a serve, could be used. Ready position, contact position, forward swing, backswing, serve, return and other shots could be provided as video inputs. Many student athletes take incorrect positions at the ready position, or incorrectly transition from the ready position to a hitting position or contact position, so that these early movements are often areas where correction is needed.

In another format, still frame shots, whether digital photographs or stills from a video sequence, of the student's and/or professional's stroke may be provided. These may be taken, for example, in bursts of 24 to 60 or even greater fps rates. Again, these photo files may record the student's and professional's stroke from setup through completion of the swing and setup for the next stroke, in the tennis application. Corresponding motions could be identified for other sports or activities. These may include dance, gymnastics, swimming, running, and any other activity with humans in motion.

At step ST03 in FIG. 2, a step labeled “Select Frames” for frame selection is performed. An operator using a personal computer or workstation retrieves the stored video files for playback and performs frame select operations. Culling or eliminating some portion of the video frames or images is performed by an operator using a computer aided tool to reduce the video sequence to the most important frames, any number of frames can be chosen. As a simple illustrative example 7, 15 or 20 video images could be selected from the series of video frames or photo images included in the video of one motion or stroke. The operator uses the video frame tools to produce an output file with the selected frames in a visual sequence, and this output file is also stored as a digital video file in a non-transitory tangible medium.

In one embodiment of the process, the first frame selected for conversion is the “ready” position of the professional although other frames may be used as the “first frames”. As mentioned above, the ready position is very important and comparison between the correct motion and the student's motion should include the ready position. The frame focal (the frame or frames that best captures the point of impact position between the ball and the racquet) is identified and subsequent video frames of images are selected based on the speed and path of the swing and on the student's swing video. The selected images may include those frames or images beginning at the ready position, the backswing, the transition frames or images where the swing transitions to follow through in the forward direction, the frames immediately before impact, and the frames depicting the impact and the frames immediately after impact. In some examples, the last frame chosen may be the frame depicting the position of the racquet at the end of its path.

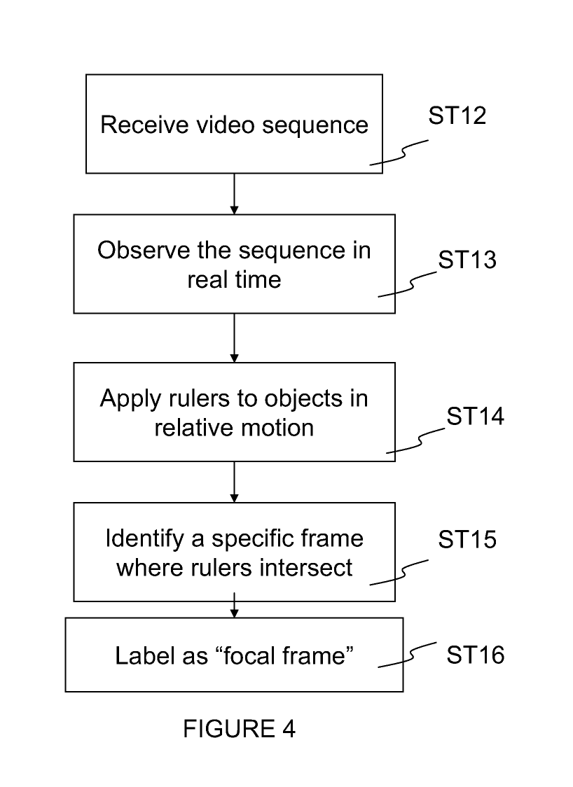

A unique tool and process, the FOP tool, may be employed in step ST02 to assist in the frame selection method of ST03. The FOP method is described in more detail below and shown in FIG. 4. The FOP tool enables an operator using a computer such as a laptop, personal computer or workstation to analyze frames by retrieving a video file, performing a video playback and examining a visual sports sequence to determine specific positions of objects captured in a video frame (for example, the objects may include the ball, the wrist, knees, racquet, arms, feet, etc.) while analyzing video produced by commercial devices such as a point and shoot camera, or consumer quality camcorder. The FOP tool enables drawing and cutting of images for subsequent use in the visual analysis. A camera shooting video at a selected frame rate always takes discrete samples. Because the human eye essentially integrates images to form a continuous image in the viewer's mind, when the stored images are retrieved and played back, discontinuities are usually not noticed by the viewer. However, a particular point in time (such as, for example, the point where a ball impacts a racquet) may not be clearly visible in any frame in the sequence.

The FOP tool makes it possible to easily identify, in a video playback at regular playback speed, the locations of objects and to apply rulers on the video frames. The FOP tool enables, for example, an operator to locate the particular frame in a sequence that best captures an event. One event typically sought after in tennis sequence is the ball striking the racquet, and this frame then becomes the “focal” frame. Using this frame as the focal frame, other frames captured before and after this frame are also selected for analysis. The FOP tool output is another video file stored in a non-transitory tangible medium for retrieval by the computer or workstation.

The embodiments also include specially developed drawing tools. These tools may be used to add, for example, clocks showing elapsed times between events, angle wheels, drawing lines may be added showing the line a ball or object such as racquet takes, and other visually significant objects or cues may be created and added to the video files. Also, the tools allow the angle an object strikes another object to be determined and using the tools, missing information may be created and added. For example, if the frame sequence does not provide the exact moment a racquet and ball are in contact, the tools allow the position of the objects to be determined from the angles, motions etc that are available, and a frame correctly depicting the desired instant may be created and added to the sequence. Thus even if the video provided does not have all of the desired frames, the analysis may be corrected and completed using the tools of the embodiments.

In step ST04 in FIG. 2, outlines of the professional athlete are trimmed from the selected video images for use in the succeeding steps. The outlines may be provided, for example, by an automated software tool processing the image frames from the FOP tool. Alternatively, the outlines are provided by a method using a computer aided graphical tool guided by an operator to add visual artifacts to a video file. For video frames with clear images, the operator can select the athlete's figure and remove it for further processing. For frames with blurred imagery, the operator may again use the FOP tool described above to locate hard to see objects and using graphical tools, add these details to those frames; then the clarified image may be used to provide the outlines for cutting out. Once all of the outlines are ready, the process continues.

At step ST05 in the process shown in FIG. 2, the selected professional video frames are retrieved from a stored video file and converted to video files containing “stick figures” or templates from a stick figure database 11. The database 11 has been designed and developed and continues to be increased. These sick figures consist of head shapes, torso shapes, wrists, hands and feet and, for the tennis application being discussed as an example here, tennis racquets. All other body parts are graphically drawn and connected using computer graphical techniques. All of these stick figures are designed to visually resemble the movement of a professional player's tennis swing. In step ST05, the selected sequence of video frames is created where the outline (now isolated for each of the selected frames) of the professional athlete is replaced with components from the “stick figure” database in a conversion process. This process is done either automatically or using graphic design utilities guided by an operator to select the appropriate stick figure component, replacing the portion of the athlete's body part in each frame in the selected frames with the stick figure component. If a particular image is not appropriately available in the stick figure database, a new stick figure may be created and stored in the database. A software utility then automatically draws appropriate connections between joints and completes the conversion process.

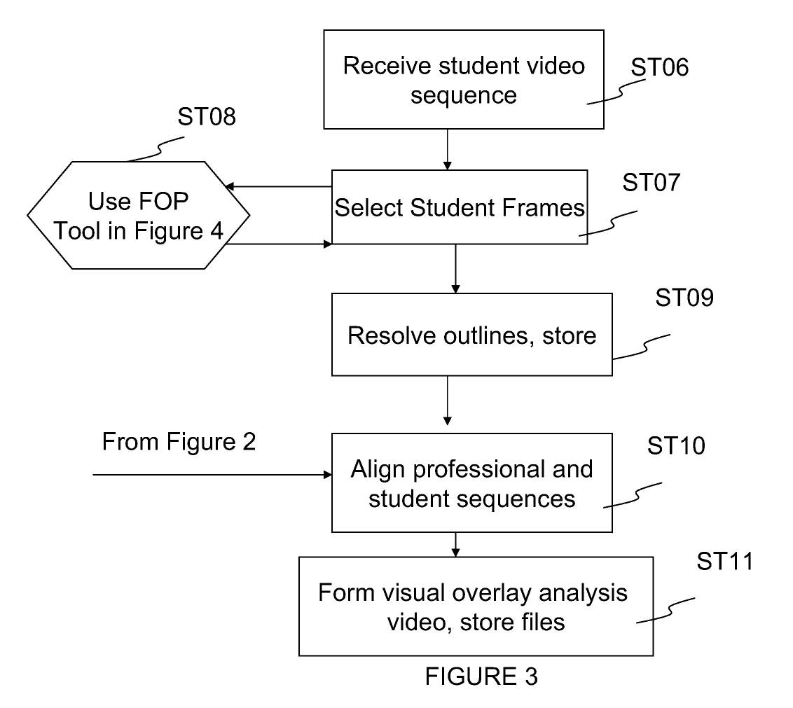

The process now continues as shown in FIG. 3. In FIG. 3, another set of steps is shown that may be performed either serially with the above steps or simultaneously with one or more of them. First, in the tennis example used here for illustration, the student's swing video is analyzed.

At step ST06, a student video sequence is received as a video file stored in a non-transitory tangible medium. At step ST07, the file is retrieved for playback and a portion of the frames from the student's swing video that approximately or best matches the frames selected from the professional's swing video is made, and these selected frames are stored as a video file for further processing. In some known examples, 15 or 20 frames were selected, although many more could be used if system resources allow. Again, the FOP tool may be used to assist in the selection, at step ST08.

At step ST09, after the student frames are selected, another outline trimming process is performed more or less in the same manner as described above with respect to the professional's image frames in FIG. 2. Once the student athlete outline figures for the selected frames are cut out and isolated, the student frame sequence is stored as a digital video file containing frames in a visual sequence ready for further processing.

In order for the visual overlay of the method to appropriately compare the two motions, the two motions should first be aligned or matched up. For example, the movement from “set up” of a motion to the initial swing motion for the professional and the student will move in varying directions. This alignment is done in step ST10 by retrieving each of the stored video files containing the two visual sequences, and using a computer and performing video playback of each file, an operator determines the frame in each sequence that represents the player's last motion before the swing begins, which in the tennis application is where the motion commits the player to a forward movement. Alternatively, the operator may identify the frames in each sequence where the professional athlete and the student athlete are in a “ready position”. At the frame in each sequence (student and professional) that represents this point, the stick figure is aligned to the image of the student; for example by aligning them at the feet or hips. Again the FOP tool may be used to assist in identifying motions or object locations to enhance this process.

In step ST11, the stick figures formed from the professional video frames are now visually overlaid with the student outlines to form a visual overlay sports motion analysis that is stored in a non-transitory tangible medium as a user ready video file. Once each frame of the student's selected frames are completed in the overlay process, the visual analysis is ready for analysis and the completed digital video overlay file is imported into the VOTSA system.

The steps described above were described in one possible order of execution. However, variations in the order of steps are possible. For example, the process applied to the professional video in FIG. 2 could be performed in advance and the “stick figure” frames could be stored in an archive for later use. The process steps ST06, ST07, ST08, ST09 applied to the student video in FIG. 3 could be applied to the student video before the process of FIG. 2 is applied to the professional video. Changing the order of steps is one variation in the methods contemplated by the inventors as part of the embodiments and as alternatives thereof, and lies within the scope of any appended claims.

The illustrative examples provided above describe embodiments directed to a tennis application in describing the VOTSA system. However, as mentioned above, this is only one example used for illustration, and the embodiments may be applied to any human or animal motions including dance, any sport, gymnastics, and other physical activities.

In certain embodiments, four additional critical components of the tennis stroke may be provided as additional VOTSA outputs.

In the Swing Path analysis, the student's swing path is measured from approximately the center of the tennis racquet, staring from the “ready” position through the completion of the tennis swing. Measuring the swing path in this manner captures the backswing, the point of contact with the ball, and the follow through. The swing paths may be color coded by adding artifacts to the visual overlay. Different colors may be used to distinguish the swing path of the professional from that of the student. These frames are selected and input into the VOTSA system for analysis.

Another component presented in certain embodiments is Shoulder Movement. In this analysis, the shoulder position of both the student and the professional are captured and isolated. A visual overlay comparison is provided so that the student and his/her instructor can visually determine how the shoulder movement of the student differs from the professional. The shoulder movement frames are also created and imported into VOTSA for analysis.

Another component presented in certain embodiments is referred to as Eye Contact. In this analysis, a line artifact is added to the visual overlay from the student's eyes and leading towards the area the student is looking at during the motion. This line then is used to indicate the student's line of sight throughout the motion. This analysis allows the student and/or their instructor to make a determination on when the student stops “watching the ball” or “keeping their eye on the ball” during the motion throughout the swing. These frames are also imported into the VOTSA system for analysis.

Another component presented in certain embodiments is Point of Contact. In Point of Contact analysis, the selected frames or images depict the contact position of the racquet of the professional and the student in a visual overlay analysis. The student and/or the instructor can then compare the point in the motion where the student contacts the ball, and where the professional contacts the ball. These frames are also imported into the VOTSA system for analysis.

By providing these components in a single package, these embodiments provide an additional advantage in that the student and instructor can quickly view each of these components, saving the student the expense of paying for instructor time to spend additional time reviewing separate analysis results.

Exemplary embodiments provide the visual overlay analysis to the student user in a variety of user friendly formats as part of the package. Note that these are examples and are not required to be used or provided to use the other embodiments described herein, the visual overlay motion analysis file alone would provide great facility for the student, but these components may be conveniently provided for additional ease of use. Advantages of the system are that any student or coach, anywhere, can submit a video file for analysis and comparison, and in a turnkey manner, receive an output file that can easily be viewed. The student or coach does not need special video or camcorder equipment, and a skilled videographer is not required. The student or operator also do not require special computing skills or even their own computer, any computer such as a school or office system or at a kiosk can be used to play back the videos, using a simple web interface tool. The embodiments enable visual comparison analysis and training to be extended to the masses, anywhere in the world. Coaches from around the world can evaluate a student that may be in another part of the world and communicate their thoughts through notes typed or voice recording on a frame by frame basis, so that the student can access and perform distance learning with these embodiments.

In one analytical component that may be provided, called the “Home Page”, the original video of the professional's stroke and the original video of the student's stroke are provided and may be selected for playback.

In another analytical component that may be provided, called the “Professional's Original Video Page”, a menu is provided for playing back the professional's video at various speeds, and for examining the sequence in a frame by frame playback view.

In another analytical component that may be provided, called the “Student's Original Video Page”, a menu is provided for selecting and playing back the student's video at various speeds and for examining the sequence in a frame by frame playback view.

In another analytical component that may be provided, called the “Overlay Analysis Page”, the visual overlay may be played back at various speeds or viewed on a frame by frame basis.

In yet another analytical component that may be provided, called the “Swing Path Analysis” page, a menu is provided for selecting and playing the swing path analysis at a variety of speeds and/or viewing it on a frame by frame basis.

In another analytical component that may be provided, called the “Technical Analysis” page, a menu is provided for selecting and playing the following items in visual overlay analysis: Swing Path, Shoulder Turn, Eye Contact, and Point of Contact.

The visual overlay analysis may appear grouped on one page as described above or on separate pages, with only one visual analysis shown per page. The visual analysis components described are only examples of the analysis that may be included. Other analysis may focus on any other part of the student's or professional's motion that is included in the video files stored on video media, such as hands, wrists, feet, legs, or head, to name a few. As described above, a grip analysis may also be provided.

These components are examples and other examples may be added, or these pages may be combined or compressed in any manner, without limiting the embodiments or the scope of the claims. The web interface and the pages described may be modified in any manner to make use of the pages and the web interface more effective.

Table 1 that follows summarizes the components of the VOTSA package.

TABLE 1
VOTSA PACKAGE COMPONENTS

```
A Home page with the following menu items for selection:
    Home
    Professional's original video
    Student's original video
A Professional's Original Video page with the following menu items for
selection:
    Play Slow
    Play Regular
    First Frame
    Previous Frame
    Next Frame
    Last Frame
    Auto Sync of the videos, with the contact or other point
A Student's Original Video page with the following menu items for
selection:
    Play Slow
    Play Regular
    First Frame
    Previous Frame
    Next Frame
    Last Frame
    Drawing tools such as clock, angle wheel, grid, drawing lines
    Auto Sync of the videos, with the contact or other point
An Overlay Analysis page with the following menu items for selection:
    Play Slow
    Play Regular
    First Frame
    Previous Frame
    Next Frame
    Last Frame
    Drawing tools such as clock, angle wheel, grid, drawing lines
A Swing Path Analysis page with the following menu items for selection:
    Play Slow
    Play Regular
    First Frame
    Previous Frame
    Next Frame
    Last Frame
    Drawing tools such as clock, angle wheel, grid, drawing lines
A Technical Analysis page with emphasis on the following items:
    Swing path
    Shoulder Turn
    Eye Contact
    Point of Contact
    Side by Side Video
    Original Video of the Student
    Original video of the Correct Motion
    Drawing Tools such as clock, angle wheel, grid, drawing lines
    Auto Sync of the videos, with the contact or other point
```

The output of the VOSMA/VOTSA package may be provided to the student or his/her instructor in a variety of ways. Conveniently, the visual overlay files may be transmitted in common user ready video player formats via email, file transfer, or downloaded from a website. Computer readable media such as USB or flash drives, DVD disks, and other non-volatile storage may be used and delivered to the student. A printable form of the images may be provided so that the student athlete can print them, and then the student may carry the analysis even when a computer or other video playback device is not available to them.

FIG. 4 depicts in a flow diagram another method embodiment for the FOP process. This process, while part of the VOTSA package, may be used as an independent method for visual analysis and is not limited in application to the VOSMA/VOTSA package.

In FIG. 4, a video sequence having objects in relative motion is received. At step ST12, the method begins by receiving, for example from a frame buffer or other video storage, a sequence. In the video objects are in relative motion, for example a bat and a ball may be included.

In step ST13, an operator observes the sequence using a tool such as in a video editing environment in video playback.

In step ST14, the operator applies rulers to the video playback. The rulers indicate the relative motion of objects in the video.

In this example, the operator seeks to use the FOP tool to identify a frame where the objects intersect, (i.e., the ball makes contact with the bat). The intersection point of the rulers identifies the frames where this may occur. In ST15, the operator finds this point in the playback.

In ST16 the “focal” frame is identified. This frame is then used as an index point to identify the frames immediately preceding, and immediately following, the focal frame for frame selection. The use of this method makes rapid and cost effective processing of the visual sequences possible, helping make the VOTSA a cost effective training tool. This embodiment, the FOP tool, may be used independently of VOTSA as a visual analysis method.

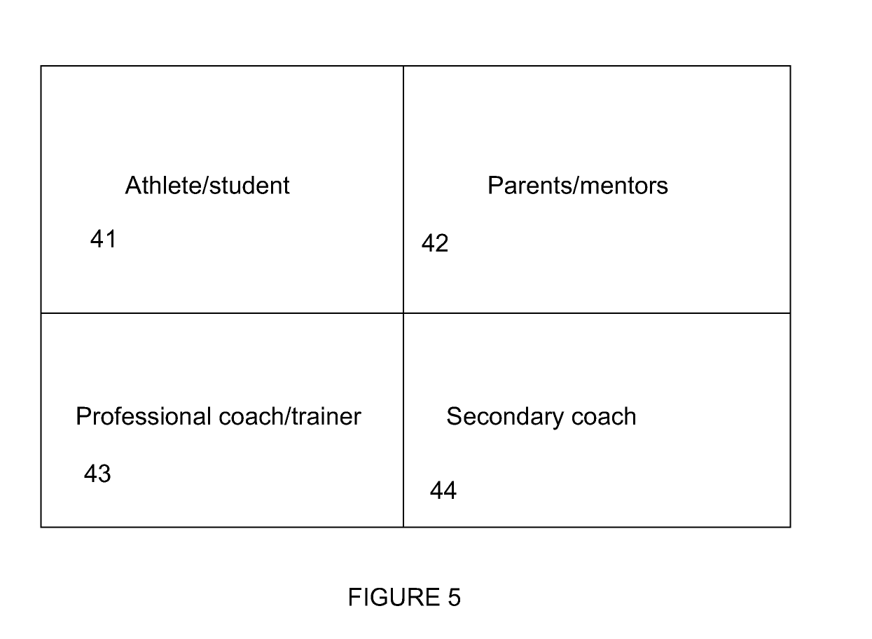

In yet another preferred embodiment, a user interface is provided that allows the student athlete, parents or mentors, professional trainers or coaches, secondary coaches, or other interested parties, using a computer or PDA and a web-based user interface, to communicate on the progress of the student athlete. FIG. 5 illustrates a graph showing the “four squares” of a student athlete's training program. The athlete is shown in square 41, the parents or mentors are in square 42, the professional coach or trainer is shown in square 43, and the secondary coach is shown in square 44. Many athletes or trainees are training with each of the persons identified in the four square diagram involved in setting practice schedules, selecting drills and workout routines, and providing correction to the athlete. These four squares visually indicate the persons that need information from the system.

The communications between all the persons involved in the athlete's training is critical to the athlete's success. The coaches and parents or mentors need to be informed of the observations and recommendations made by the other persons in the four squares, each of whom is involved in the training. In the communication embodiment, the system allows coaches notes and comments to be created and added to the visual sequences and stored along with the visual sequence for each frame of the video analysis. These notes are coordinated with the visual sequences and stored in a non-transitory tangible medium in a manner where they can be retrieved for playback by the other persons involved, including by the athlete. The coaches' notes may include suggested drills and practice routines designed to correct the errors seen in the athlete's motions or positions. The communications tool embodiment may include a calendar feature with a workout and other commitments tracking system, so that all of the parties are informed of the time commitment and efforts put forth by the student. The communication embodiment allows for the use of additional features such as auto texting (text to a cellular device or computer) and automatic emailing of updates made through the calendar function. In this way communication is facilitated among the “four squares” and the other persons involved in the training program.

In yet another preferred embodiment, a video graph or video history feature is provided. This video graph or video history feature allows the student's motions and the progress in attempts to correct the motions to be documented. Video files containing video of the athlete performing the motions are stored with individual date or time stamps. These stored video files may be added as retrievable files on a user interface such as a web page, or stored locally by the user at their computer. Comparison video files may be created for playback presenting a visual comparison between the student videos. These visual comparisons may be presented in side by side visual displays. The auto sync feature may be used to play back two video sequences starting just before a common critical point, such as at a ready position or point of contact using a single command or “button” on the interface. Alternatively, one video file can be used as an overlay file and a visual overlay video file can be created with another video file, displaying the athlete's motions captured at different times in a visual overlay comparison. The video graph feature of this embodiment allows the benchmarking and documentation of a trainee's progress,

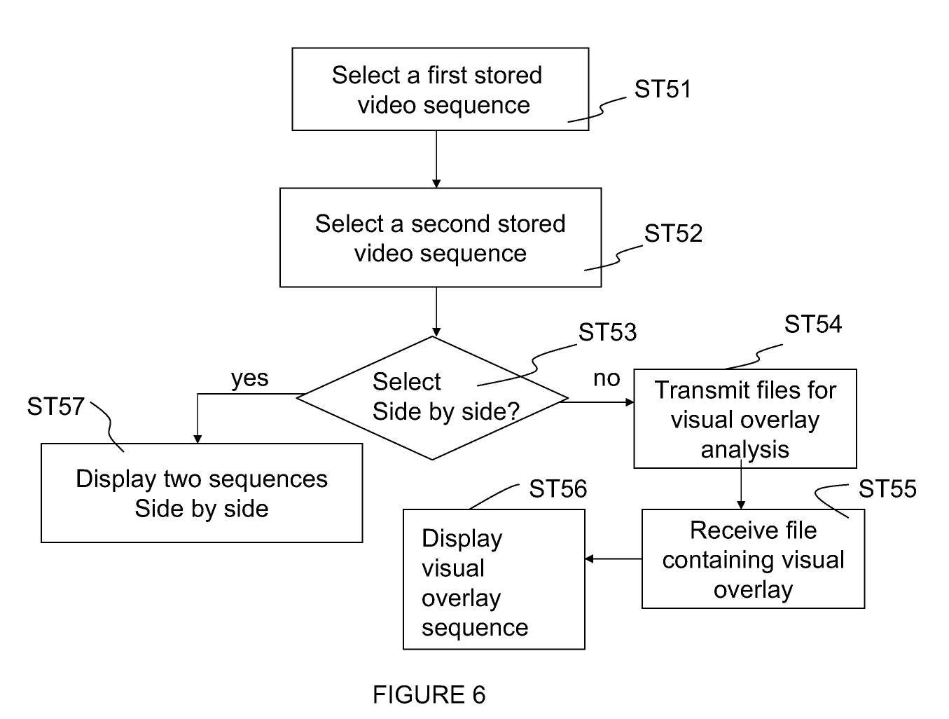

FIG. 6 depicts in a flow diagram the steps that are performed in this embodiment. In step ST51, a first time or date stamped video sequence file is selected from among stored date or time stamped video files. This may be done at a computer that includes storage of the files locally, or more likely, over a web based user interface to a web hosting service that stores the files as individual athlete's video files on a file server. In step ST52, a second time or date stamped video sequence is selected for comparison to the first file. In step ST53, a simple decision is made. If the playback of a comparison is needed immediately and with a minimum of additional time, a side by side comparison may be performed immediately by playing back the two stored video files in a visual side by side display. This is shown as step ST57. Step ST57 may include the use of the auto sync feature in playback.

However, it also possible to select, in step ST54, indicating a visual overlay comparison is selected. In this embodiment, the two files are put through the visual overlay process described above and shown in FIGS. 2, 3 and 4. A visual overlay file is returned at step ST55. The visual overlay process requires an operator using the methods provided above to process the two video files, identify the frames for analysis, add artifacts such as stick figures, and produce the visual overlay file. When the visual overlay comparison file is ready it may be provided to the user for playback, for example, as a downloadable file saved on a web server and transferred via a web interface. The user can then observe the visual overlay by performing a video playback of the visual overlay file, at step ST56. In this manner, the student athlete can see in a visual sequence the changes made and the progress towards performing the correct motion over time.

In yet another embodiment a video sequence of the student athlete's motion, or an individual frame or frames of the student athlete's motion, is altered using the video frame tools of the system. The altered visual sequence or frame is used to present a visual image or video sequence of the athlete shown performing the motion using the technically correct positions and movements. This file is then stored in a non-transitory tangible medium for playback. This feature allows the student to see a visual representation of himself/herself performing the motion correctly. The student can then form a mental image of himself/herself performing the motion correctly in his/her mind, which makes it possible for the student to perform the motion correctly. In performing this method, the student, coach or trainer selects a video file of the student performing the motion for analysis, and the file is put through a process similar to the process for the visual overlay analysis. The tools of the system are used, with an operator's input, to alter the visual representation of the athlete to visually show the correct motion, and an altered visual sequence file is created and stored. When the file is ready, it may again be provided to the user for playback, for example, as a downloadable file saved on a web server and transferred via a web interface. The user can then observe the visual overlay by performing a video playback of file.

The above description of the various embodiments was provided using a tennis application as an illustrative, exemplary and non limiting, example. However, as described above, the embodiments and the scope of any appended claims hereto are not so limited. Obvious substitutions of known equivalent methods and structures, and modifications obvious to one skilled in the art such as changes in the order of steps described and the like, are contemplated by the inventors as alternative embodiments and fall within the scope of any appended claims.

The tools of the embodiments allow for comparing video clips with different date and time stamps. The use of the communications embodiment allows the student's coaches notes, activities, calendar of athletic and school functions, events and commitments to be effectively communicated among the concerned parties who participate in the training of the athlete.

Advantages of the use of the preferred embodiment methods are that a student athlete and/or his/her instructor can receive a visual overlay sports motion analysis providing a playable visual comparison of the performance of a sports motion to a professional athlete. Additional analytical components such as visual overlay analysis of grip, swing motion, point of contact, eye contact, and shoulder turn may be provided. The visual overlay analysis may be observed in normal playback, slow motion, or frame by frame. The visual motion analysis is created from video taken with consumer grade and readily available equipment and the visual analysis output is returned in a user friendly technology format compatible with many devices already in use in most households, such as PCs, laptops, PDAs, cellphones, MP3 players and the like. Because the system provides a turnkey facility, the student and coach do not need any particular skills in manipulating computer files, using video editors or videography, or computing to use the system. Rather, a simple web interface may be used with any computer anywhere.

By providing immediate visual information to the student athlete, changes needed in a sports motion are directly communicated and the student can see their own motion in real time comparison to a correct motion. Errors in communication and in understanding verbal instruction or commands are eliminated and the student's performance of the motion can therefore rapidly improve.

Use of the embodiments advantageously provide the student's video sequences as stored files of video clips that are saved and stored and viewable on a single, easy to use web page. The availability of visual comparison training of a student or trainee to a professional athlete to anyone, student and/or their coach, at an affordable cost, regardless of their location in the world and without regard to any membership in elite clubs or schools, and without regard to socio-economic factors, is unique and will level the playing field for many athletes who previously did not have the ability to gain the advantages of visual comparison training.

Although the various embodiments and advantages have been described in detail, it should be understood that various changes, substitutions and alterations can be made herein without departing from the spirit and scope of the invention as defined by the appended claims. For example, many of the features and functions discussed above can be implemented in software, hardware, or firmware, or a combination thereof. Some method steps may be performed either automatically, or by an operator using computer automated design or graphics tools.

Moreover, the scope of the present application is not intended to be limited to the particular embodiments of the process, machine, manufacture, and composition of matter, means, methods and steps described in the specification. As one of ordinary skill in the art will readily appreciate from the disclosure of the embodiments, processes, machines, manufacture, compositions of matter, means, methods, or steps, presently existing or later to be developed, that perform substantially the same function or achieve substantially the same result as the corresponding embodiments described herein may be utilized according to the present invention. Accordingly, any appended claims are intended to include within their scope such processes, machines, manufacture, compositions of matter, means, methods, or steps.

What is claimed is:

1. A method for performing a visual motion analysis, comprising:
receiving a first video file containing video frames recording a first motion performance that is known to be correct;
using a computer, identifying a first selection of video frames from the first motion performance for analysis;
retrieving from the first selection of video frames, for each frame, an outline of a professional athlete or trainer performing the first motion performance and storing the outlines as a sequence of frames;
using a computer, converting, for each frame having stored outlines, the outlines into stick figure templates representing the limbs, head, and torso of the athlete and sports equipment used in the first motion performance and storing the conversions as stick figure video frames;
receiving a video file for a student athlete containing video frames recording a second motion performance to be analyzed;
using a computer, identifying a second selection of video frames from the second motion performance that corresponds to the selected frames in the first motion performance and storing the second selection;
retrieving from the second selection, for each frame, an outline of the student athlete performing the motion and storing the outlines as second outline frames;
using a computer, visually overlaying for each of the second outline frames, the stick figure video frames and storing overlay video frames; and
storing in a non-transitory tangible medium readable by a computer the resulting overlay video frames as an output video file containing frames that form a playable visual overlay motion analysis providing visual comparison between the second motion performance and the first motion performance.

2. The method of claim 1, and further comprising:
retrieving the stored output video file using a computer; and
displaying the stored output video file as a sequence of video frames.

3. The method of claim 1, wherein using a computer, identifying a second selection of video frames from the second video performance that corresponds to the selected frames in the first video performance further comprises identifying a selection of video frames corresponding to a ready position.

4. The method of claim 1, wherein the first video file contains video sequences of a professional athlete performing a correct motion.

5. The method of claim 1, wherein the first video file contains video sequences formed of animated figures performing a correct motion.

6. The method of claim 2, and further comprising:
storing, for selected frames within the output video file, notes indicating corrective actions that should be taken.

7. The method of claim 1, wherein the first video file contains video sequences of a correct motion for tennis.

8. The method of claim 1, wherein the overlay video file includes images of the professional athlete's or trainer's grip of an object.

9. A method for locating an object position in a video sequence, comprising:
using a computer, receiving a video file containing a video stream comprising video frames depicting at least one object in motion in relation to other depicted objects;
using the computer, playing the video stream in real time;
using the computer, creating a second video file by adding one or more visual artifacts drawn to illustrate the relative position of the object over time, and storing the second video file on a non-transitory tangible medium that is computer readable;
using the computer, creating a third video file by identifying a desired location by adding a second visual artifact that intersects the first visual artifact and storing the third video file; and
using the computer, labeling a particular video frame corresponding to the time the intersection occurs between the two visual artifacts as the focal frame, and storing the labeled video frame in a non-transitory tangible medium that is readable by a computer.

10. The method of claim 9, wherein receiving the video file comprises loading a file via an internet interface.

11. The method of claim 9, wherein receiving the video file comprises receiving an email message using a computer with a file attachment.

12. The method of claim 9, wherein receiving the video file comprises receiving a video file containing a video sequence of a professional athlete performing a correct motion.

13. The method of claim 12, wherein the correct motion is a human motion.

14. The method of claim 12, wherein the correct motion is a tennis motion.

15. A method for communicating between persons training an athlete using visual comparisons, comprising:
receiving a first video file containing video frames recording a first motion performance by an athlete that is known to be correct;
using a computer, identifying a selection of video frames from the first motion performance for analysis;
retrieving from the selection of video frames, for each frame, an outline of the athlete performing the first motion performance and storing the outlines as a sequence of frames;
using a computer, converting, for each frame having stored outlines, the outlines into stick figure templates representing the limbs, head, and torso of the athlete and sports equipment used in the first motion performance and storing the conversions as stick figure video frames;
receiving a student video file for a student athlete containing video frames recording a second motion performance to be analyzed;
using a computer, identifying a second selection of video frames from the second video performance that corresponds to the selected frames in the first video performance and storing the second selection;
retrieving from the second selection, for each frame, an outline of the student athlete performing the motion and storing the outlines as second outline video frames;
using a computer, visually overlaying, for each of the second outline video frames, the stick figure video frames and storing overlay video frames;
storing in a non-transitory tangible medium readable by a computer the resulting overlay video frames as an output video file containing frames that form a playable visual overlay motion analysis providing comparison between the student athlete motion performance and the first motion performance; and
providing a user interface where persons training the student athlete can retrieve the stored output video file and attach notes stored in a file that corresponds to the video frames of the stored output video file.

16. The method of claim 15, wherein providing a user interface further comprises providing access to the notes and stored output video file over an internet connection for visual playback of the video file while the notes are contemporaneously displayed.

17. The method of claim 15, wherein the first motion is performed by a professional athlete.

18. The method of claim 15, and further comprising providing a side by side playback where the first motion and the stored output video file can be played visually together and automatically synchronized to a ready position in both the first motion performance and the output video file.

19. The method of claim 15, and further comprising providing drawing tools wherein one selected from the group consisting essentially of a clock, angle, angle wheel, and drawing lines can be added to the first motion or the student video file for visual playback.

20. The method of claim 15 and further comprising:
receiving from a professional athlete a still image of a correct grip characterization and including visual cues added to the visual analysis of the grip such as bezel lines and numbering.
